(19) United States
(12) Patent Application Publication
(10) Pub. No.: US 2026/0235844 A1
(43) Pub. Date: Aug. 13, 2026

(54) OPTICAL IMAGING LENS

(71) Applicant: GENIUS ELECTRONIC OPTICAL (XIAMEN) CO., LTD., Xiamen (CN)

(72) Inventors: Zhizhong Ji, Xiamen (CN); Chen Chen, Xiamen (CN); Yidian Chen, Xiamen (CN)

(73) Assignee: GENIUS ELECTRONIC OPTICAL (XIAMEN) CO., LTD., Xiamen (CN)

(21) Appl. No.: 19/467,810

(22) Filed: Feb. 3, 2026

Related U.S. Application Data
(63) Continuation-in-part of application No. 19/060,787, filed on Feb. 24, 2025.

(30) Foreign Application Priority Data
Dec. 24, 2024 (CN) 202411918315.4
Jan. 21, 2025 (CN) 202510091847.3
Aug. 5, 2025 (CN) 202511091773.X
Aug. 5, 2025 (CN) 202511091877.0
Dec. 23, 2025 (CN) 202511949045.8
Dec. 23, 2025 (CN) 202511950889.4

(51) Int. Cl. G02B 7/02

(52) U.S. Cl. CPC G02B 7/021

(57) ABSTRACT

An optical imaging lens includes an outer cover, a lens barrel, and multiple lens elements. A front end portion of the lens barrel includes a lens barrel object-side opening. A back end portion of the lens barrel includes a lens barrel image-side opening. An inner diameter of the lens barrel object-side opening is less than an inner diameter of the lens barrel image-side opening. The outer cover is cone-shaped and is disposed on an outer surface of the front end portion of the lens barrel. The outer cover includes an outer cover object-side opening and an outer cover image-side opening. A maximum outer diameter of the outer cover object-side opening is less than a maximum outer diameter of the outer cover image-side opening. A length of the outer cover on an optical axis is greater than 40% of a length of the lens barrel on the optical axis.

### CROSS-REFERENCE TO RELATED APPLICATION

This application is a continuation-in-part of and claims the priority benefit of U.S. application Ser. No. 19/060,787, filed on Feb. 24, 2025, which claims the priority benefits of China application serial no. 202411918315.4, filed on Dec. 24, 2024, and China application serial no. 202510091847.3, filed on Jan. 21, 2025. In addition, this application also claims the priority benefits of China application serial nos. 202511091773.X and 202511091877.0, both filed on Aug. 5, 2025, and China application serial nos. 202511949045.8 and 202511950889.4, both filed on Dec. 23, 2025. The entirety of each of the above-mentioned patent applications is hereby incorporated by reference herein and made a part of this specification.

### BACKGROUND

### Technical Field

The disclosure relates to an optical element, and more particularly, to an optical imaging lens.

### Description of Related Art

Specifications of portable electronic devices are constantly evolving, and key components thereof, optical imaging lenses, are also required to be continuously improved in specifications to meet consumer demands and be applied in various fields. Those skilled in the art know that using plastic materials to manufacture lens barrels, in addition to being easy to process, may also reduce the weight and cost, and therefore are widely applied in various optical lenses.

In the Chinese Utility Model Patent, CN209387961U, a lens module is provided. A metal insert is disposed in a plastic lens barrel. A supporting portion of the metal insert is disposed around an outer periphery of a top of the plastic lens barrel, which may protect the plastic lens barrel and improve structural strength of a top position of the lens barrel, so that the top of the lens barrel has good pressure resistance. However, from the cross-section, it has a structure with chamfers, where stress is more concentrated. Although it has pressure resistance at the top, it is easily damaged at a front end of a lens by impacts from other directions. In addition, no solution is provided for both reducing stray light and resisting drops.

In the Chinese Utility Model Patent, CN209525509U, in order to solve an issue that when a threadless lens barrel structure is matched with the lens, since strong glue is required to be used for high temperature curing, a thinner portion of a lens barrel wall thickness will be deformed, making it difficult for the lens to be matched with the lens barrel, a solution is provided. An implementation method thereof is to affix a metal sleeve to an outer surface of the lens barrel, so that after the lens barrel is cured at a high temperature, the thinner portion of the lens barrel wall thickness is protected by the metal sleeve, thereby enhancing overall strength of the lens barrel, making it less likely to deform, improving an ability of the lens barrel to resist deformation, and thus improving performance of the lens module. The lens barrel and the metal sleeve are integrally formed during an injection molding process, which may increase firmness of the lens module. However, in this case, it also has a structure with chamfers, where stress is more concentrated. In addition, it does not provide a method for improving structural strength of a top of an object-side end of the lens barrel while reducing the stray light, and it does not disclose how to maintain the structural strength of the lens while reducing a volume of the lens to prevent external impacts and drops from affecting performance of the lens.

In the Chinese utility model patent, CN208907936U, a lens module is provided. A lens barrel thereof includes a metal sleeve embedded in the lens barrel, and the lens barrel and the metal sleeve are formed integrally. The metal sleeve embedded in the lens barrel may greatly improve the ability of the lens barrel to resist deformation, so that when the lens barrel is assembled to the lens module, it will not be deformed due to the use of the strong glue for high temperature curing, thereby improving assembly stability and improving a product yield. However, the manufacturing difficulty and cost of this metal sleeve embedded in the lens barrel are high, and it also has a structure with chamfers, where stress is more concentrated. In addition, since an impact-receiving surface is still made of a plastic material, impact resistance is limited under the volume of the miniaturized lens.

With a trend of the portable electronic devices pursuing thin and short sizes, a volume of the lens module is getting smaller and smaller. Therefore, strength of the plastic material is no longer sufficient for the lens barrel to resist collisions and drops, resulting in the lens barrel being unable to protect internal components. Therefore, it is an objective that is required to be worked on today to provide a simple and economical way to improve the structural strength of the miniaturized lens module and prevent the external impacts and drops from affecting the performance of the lens while reducing the stray light.

### SUMMARY

The disclosure provides an optical imaging lens, which may be beneficial to an outer cover, a lens barrel, and multiple lens elements being arranged in sequence for easy assembly, enhancing structural strength of a front end portion of the lens barrel, reducing a volume of the optical imaging lens while improving a drop resistance.

The disclosure provides an optical imaging lens, including an outer cover, a lens barrel, and multiple lens elements disposed in the lens barrel from an object side to an image side along an optical axis. The lens barrel includes a front end portion close to the object side and a back end portion close to the image side. The front end portion includes a lens barrel object-side opening, the back end portion includes a lens barrel image-side opening, and an inner diameter of the lens barrel object-side opening is less than an inner diameter of the lens barrel image-side opening. The front end portion of the lens barrel has a lens barrel annular plane perpendicular to the optical axis and located on a reference plane. The outer cover is cone-shaped and is disposed on an outer surface of the front end portion of the lens barrel. The outer cover includes an outer cover object-side opening and an outer cover image-side opening, and a maximum outer diameter of the outer cover object-side opening is less than a maximum outer diameter of the outer cover image-side opening. The outer cover has an outer cover annular plane close to the object side and perpendicular to the optical axis, and an inner ring conical surface and an outer cover conical surface adjacent to the outer cover annular plane. A length of the outer cover on the optical axis is greater than 40% of a length of the lens barrel on the optical axis. The optical imaging lens satisfies a following condition, 0.450≤Tcv/Wbr≤1.400, where Tcv is a thickness of the outer cover on the reference plane, and Wbr is a width of the lens barrel annular plane on the reference plane.

In an embodiment of the disclosure, the optical imaging lens further includes a pressure sensitive adhesive disposed between the outer cover and the lens barrel.

In an embodiment of the disclosure, the outer cover includes at least one outer cover embedding structure, the lens barrel includes at least one lens barrel embedding structure, and the outer cover is combined with the at least one lens barrel embedding structure of the lens barrel through the at least one outer cover embedding structure.

In an embodiment of the disclosure, a number of the at least one outer cover embedding structure is the same as a number of the at least one lens barrel embedding structure, and the at least one lens barrel embedding structure is a protruding structure and adjacent to the outer cover image-side opening.

The disclosure provides an optical imaging lens, including an outer cover, a lens barrel, and a plurality of lens elements disposed in the lens barrel from an object side to an image side along an optical axis. A material of the outer cover is different from a material of the lens barrel. The lens barrel includes a front end portion close to the object side and a back end portion close to the image side. The front end portion includes a lens barrel object-side opening, the back end portion includes a lens barrel image-side opening, and an inner diameter of the lens barrel object-side opening is less than an inner diameter of the lens barrel image-side opening. The front end portion of the lens barrel has a lens barrel annular plane perpendicular to the optical axis and located on a reference plane. The outer cover is cone-shaped and is disposed on an outer surface of the front end portion of the lens barrel. The outer cover includes an outer cover object-side opening and an outer cover image-side opening, and a maximum outer diameter of the outer cover object-side opening is less than a maximum outer diameter of the outer cover image-side opening. The outer cover has a cover bonding surface, the lens barrel and the outer cover are bonded by dispensing adhesive between the outer surface and the cover bonding surface, and the cover bonding surface has multiple annular grooves. The optical imaging lens satisfies a following condition, 2.600≤Tcv/Ds≤6.000, where Tcv is a thickness of the outer cover on the reference plane, and Ds is a maximum depth of the annular grooves.

In an embodiment of the disclosure, a minimum distance from the outer cover object-side opening of the outer cover to the annular grooves is between 0.550 to 0.700 mm.

In an embodiment of the disclosure, the optical imaging lens satisfies a following condition, 2.800≤Lc/(n*Ls)≤4.700, from the outer cover object-side opening to the outer cover image-side opening along the cover bonding surface is a first direction, where Lc is a minimum length of the cover bonding surface from the outer cover object-side opening to the outer cover image-side opening, Ls is a maximum length of each of the annular grooves in the first direction, and n is a number of the annular grooves.

In an embodiment of the disclosure, the annular grooves are disposed periodically.

In an embodiment of the disclosure, the optical imaging lens satisfies a following condition, 2.300≤Lc/(n*Lps)≤2.900, where Lc is a minimum length of the cover bonding surface from the outer cover object-side opening to the outer cover image-side opening, Lps is a minimum length between any two adjacent ones of the annular grooves, and n is a number of the annular grooves.

In an embodiment of the disclosure, the optical imaging lens further includes a colloid disposed between the outer cover and the lens barrel.

In an embodiment of the disclosure, one of the lens elements closest to the object side is a first lens element, and the outer cover is in contact with an object-side surface of the first lens element.

In an embodiment of the disclosure, an included angle between the outer cover annular plane and the outer cover conical surface is between 100 to 110 degrees.

In an embodiment of the disclosure, a material of the outer cover is metal.

In an embodiment of the disclosure, the outer cover is a soft material, a Shore A hardness thereof ranges from 70 to 90.

In an embodiment of the disclosure, the outer cover is in contact with the lens barrel annular plane.

In an embodiment of the disclosure, the optical imaging lens satisfies a following condition, 1.120≤Dcv/Dbr≤1.201, where Dcv is a maximum outer diameter of the outer cover on the reference plane, and Dbr is a maximum outer diameter of the lens barrel on the reference plane.

In an embodiment of the disclosure, the optical imaging lens satisfies a following condition, 1.000≤Dinmax/Dinmin≤1.400, where Dinmax is a maximum inner diameter of an inner ring conical surface, and Dinmin is a minimum inner diameter of the inner ring conical surface.

In an embodiment of the disclosure, the optical imaging lens satisfies a following condition. 1.150≤Dcvox/Dcvon≤1.500, where Devox is a maximum outer diameter of the outer cover, and Dcvon is a minimum outer diameter of the outer cover.

In an embodiment of the disclosure, an air gap is between the outer surface of the front end portion of the lens barrel and the outer cover.

In an embodiment of the disclosure, a length of the air gap on the optical axis is 20% to 40% of a length of the outer cover on the optical axis.

In an embodiment of the disclosure, the outer surface of the lens barrel is provided with multiple dispensing areas and multiple matching areas arranged alternately, a number of the dispensing areas is the same as a number of the matching areas, and each of the dispensing areas has a receiving groove for receiving glue. A depth of the receiving groove is between 0.005 to 0.100 mm, and the matching areas are in direct contact with the outer cover.

In an embodiment of the disclosure, the number of the dispensing areas is at least 3 and at most 12.

In an embodiment of the disclosure, the optical imaging lens satisfies a following condition, 3.100≤Pbr/Smin≤12.50, where Pbr is a minimum circumference of the lens barrel object-side opening, and Smin is a minimum arc length of one of the dispensing areas close to the object side.

In an embodiment of the disclosure, the optical imaging lens satisfies a following condition, 4≤CTEpc/CTEoc≤10, where CTEpc is a thermal expansion coefficient of the lens barrel, and CTEoc is a thermal expansion coefficient of the outer cover.

In an embodiment of the disclosure, the colloid is solid at less than 90° C., and is in a softened state when heated again to 50° C. to 75° C.

Based on the above, in the optical imaging lens of the disclosure, the optical imaging lens includes the outer cover, the lens barrel, and the lens elements disposed in the lens barrel along the optical axis from the object side to the image side. The front end portion of the lens barrel includes the lens barrel object-side opening, and the back end portion of the lens barrel includes the lens barrel image-side opening. The inner diameter of the lens barrel object-side opening is less than the inner diameter of the lens barrel image-side opening. Therefore, it is not only advantageous to arrange the outer cover, the lens barrel, and the lens elements in sequence for easy assembly, but also advantageous to reduce the volume of the optical imaging lens while maintaining the wall thickness of the lens barrel. In addition, the outer cover includes the outer cover object-side opening and the outer cover image-side opening, and the maximum outer diameter of the outer cover object-side opening is less than the maximum outer diameter of the outer cover image-side opening. Therefore, the configuration of the outer cover may help to improve the strength of the front end portion of the lens barrel. In addition, the length of the outer cover on the optical axis is greater than 40% of the length of the lens barrel on the optical axis. Therefore, the protection area of the lens barrel may be increased, and the bonding force between the outer cover and the lens barrel may also be increased, thereby improving the drop resistance. In addition, the cone shape of the outer cover is not only easy to process, but also may disperse the impact force when it is disposed on the outer surface of the lens barrel. The design thereof without the chamfered structure may also reduce the stress concentration, which may effectively avoid the external impacts or drops, thereby reducing the possibility of local deformation and protecting the safety of the internal components. In addition, the optical imaging lens satisfies the following condition, 0.450≤Tcv/Wbr≤1.400, where Tcv is the thickness of the outer cover on the reference plane, and Wbr is the width of the lens barrel annular plane on the reference plane. Therefore, by controlling the ratio of the width of the lens barrel annular plane to the thickness of the outer cover, the volume of the miniaturized lens may be maintained while ensuring the intensity of the drop resistance of the optical imaging lens.

In order for the aforementioned features and advantages of the disclosure to be more comprehensible, embodiments accompanied with drawings are described in detail below.

### BRIEF DESCRIPTION OF THE DRAWINGS

FIG. 1 is a schematic cross-sectional view of an optical imaging lens according to the first embodiment of the disclosure.

FIG. 2 is a schematic cross-sectional view of an optical imaging lens according to the second embodiment of the disclosure.

FIG. 3 is a schematic cross-sectional view of an optical imaging lens according to the third embodiment of the disclosure.

FIG. 4 is a schematic cross-sectional view of an optical imaging lens according to the fourth embodiment of the disclosure.

FIG. 5 is a schematic cross-sectional view of an optical imaging lens according to the fifth embodiment of the disclosure.

FIG. 6 is a schematic front view of an optical imaging lens according to the fifth embodiment of the disclosure.

FIG. 7 is a schematic front view of an optical imaging lens according to the sixth embodiment of the disclosure.

FIG. 8 is a schematic front view of an optical imaging lens according to the seventh embodiment of the disclosure.

FIG. 9 shows values of various important parameters and relational expressions thereof of the optical imaging lenses according to the first to seventh embodiments of the disclosure.

FIG. 10 is a schematic cross-sectional view of an optical imaging lens according to the eighth embodiment of the disclosure.

FIG. 11 is a schematic cross-sectional view of an optical imaging lens according to the ninth embodiment of the disclosure.

FIG. 12 is a schematic cross-sectional view of an optical imaging lens according to the tenth embodiment of the disclosure.

FIG. 13 is a schematic cross-sectional view of an optical imaging lens according to the eleventh embodiment of the disclosure.

FIG. 14 shows values of various important parameters and relational expressions thereof of the optical imaging lens according to the eighth to eleventh embodiments of the disclosure.

### DETAILED DESCRIPTION OF DISCLOSED EMBODIMENTS

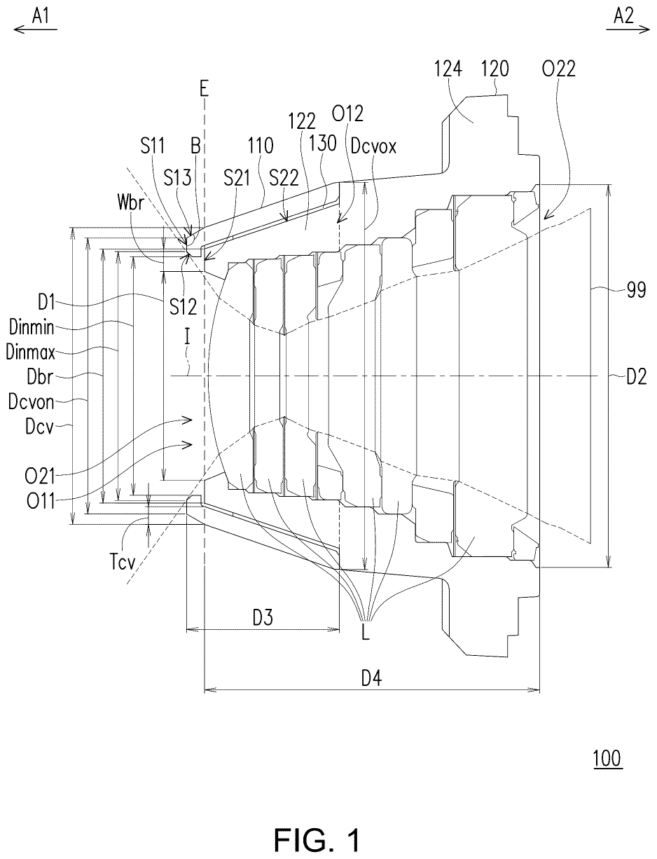

FIG. 1 is a schematic cross-sectional view of an optical imaging lens according to the first embodiment of the disclosure. Referring to FIG. 1, in this embodiment, an optical imaging lens 100 is provided, which includes an outer cover 110, a lens barrel 120, and multiple lens elements L disposed in the lens barrel 120 along an optical axis I from an object side A1 to an image side A2. When light emitted by an object to be photographed enters the optical imaging lens 100 and passes through the lens elements L and filters, an image is formed on an image plane 99. In all embodiments of the disclosure, the number, shape, material, and type of the lens elements L are not limited.

The lens barrel 120 includes a front end portion 122 close to the object side A1 and a back end portion 124 close to the image side A2. Specifically, the front end portion 122 and the back end portion 124 are defined to distinguish relative positions, and the lens barrel 120 may be designed to be integrally formed without obvious boundaries. The front end portion 122 includes a lens barrel object-side opening O21, and the back end portion 124 includes a lens barrel image-side opening O22. An inner diameter D1 of the lens barrel object-side opening O21 is less than an inner diameter D2 of the lens barrel image-side opening O22. Therefore, it is not only advantageous to arrange the outer cover 110, the lens barrel 120, and the lens elements L in sequence for easy assembly, but also advantageous to reduce a volume of the optical imaging lens 100 while maintaining a wall thickness of the lens barrel 120. The front end portion 122 of the lens barrel 120 has a lens barrel annular plane S21 perpendicular to the optical axis I and located on a reference plane E, and an outer surface S22 facing away from a side of the optical axis I.

The outer cover 110 is cone-shaped, specifically, truncated cone-shaped, and is disposed on the outer surface S22 of the front end portion 122 of the lens barrel 120. The outer cover 110 includes an outer cover object-side opening O11 and an outer cover image-side opening O12. A maximum outer diameter of the outer cover object-side opening O11 (i.e., a minimum outer diameter Dcvon of the outer cover 110) is less than a maximum outer diameter of the outer cover image-side opening O12 (i.e., a maximum outer diameter Dcvox of the outer cover 110).

Therefore, the configuration of the outer cover 110 may help to improve strength of the front end portion 122 of the lens barrel 120. In addition, the cone shape of the outer cover 110 is not only easy to process, but also may disperse impact force when it is disposed on the outer surface S22 of the lens barrel 120. A design thereof without a chamfered structure may also reduce stress concentration, which may effectively avoid external impacts or drops, thereby reducing a possibility of local deformation and protecting safety of internal components. The outer cover 110 has an outer cover annular plane S11 close to the object side A1 and perpendicular to the optical axis I, an inner ring conical surface S12 adjacent to the outer cover annular plane S11 and facing the optical axis I, and an outer cover conical surface S13 adjacent to the outer cover annular plane S11 and away from the optical axis I. The inner ring conical surface S12 of the outer cover 110 not only reduces generation of stray light, but also enhances strength of the outer cover object-side opening O11. A length D3 of the outer cover 110 on the optical axis I is greater than 40% of a length D4 of the lens barrel 120 on the optical axis I, which may increase a protection area of the lens barrel and also increase bonding force between the outer cover 110 and the lens barrel 120, thereby improving drop resistance.

In this embodiment, the optical imaging lens 100 further includes a pressure sensitive adhesive (PSA) 130 disposed between the outer cover 110 and the lens barrel 120 to fix the outer cover 110 to the lens barrel 120. In this way, the bonding force may be increased, and the PSA 130 has buffering force, which may enable the optical imaging lens 100 to be more resistant to dropping.

In this embodiment, an included angle B between the outer cover annular plane S11 and the outer cover conical surface S13 is between 100 and 110 degrees. In this way, it may disperse the impact force and reduce the stress concentration. In this embodiment, the included angle B between the outer cover annular plane S11 and the outer cover conical surface S13 is, for example, 105 degrees.

In this embodiment, a material of the outer cover 110 is metal, which may provide the optical imaging lens 100 with high strength and hardness characteristics and good drop resistance.

In this embodiment, the outer cover 110 is in contact with the lens barrel annular plane S21 of the lens barrel 120. Therefore, the outer cover 110 may cover a front end of the lens barrel 120, thereby increasing impact resistance of the front end portion 122 of the lens barrel 120.

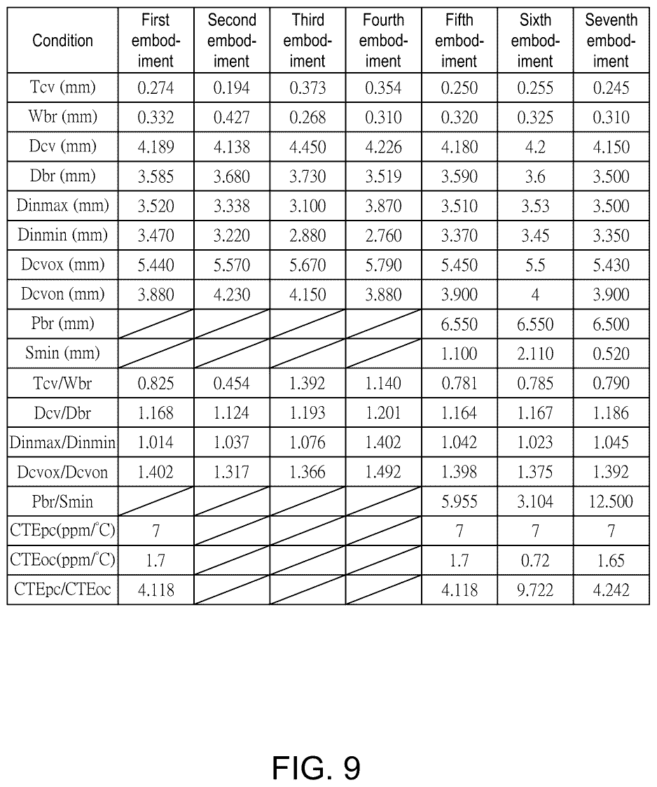

In addition, a relationship between various important parameters of the optical imaging lens 100 in the first embodiment is shown in FIG. 9,
where
Tcv is a thickness of the outer cover 110 on the reference plane E;
Wbr is a width of the lens barrel annular plane S21 on the reference plane E;
Dcv is a maximum outer diameter of the outer cover 110 on the reference plane E;
Dbr is a maximum outer diameter of the lens barrel 120 on the reference plane E;
Dinmax is a maximum inner diameter of the inner ring conical surface S12;
Dinmin is a minimum inner diameter of the inner ring conical surface S12;
Dcvox is the maximum outer diameter of the outer cover 110;
Devon is the minimum outer diameter of the outer cover 110;
Pbr is a minimum circumference of the lens barrel object-side opening O21;
Smin is a minimum arc length of one of multiple dispensing areas M close to the object side A1

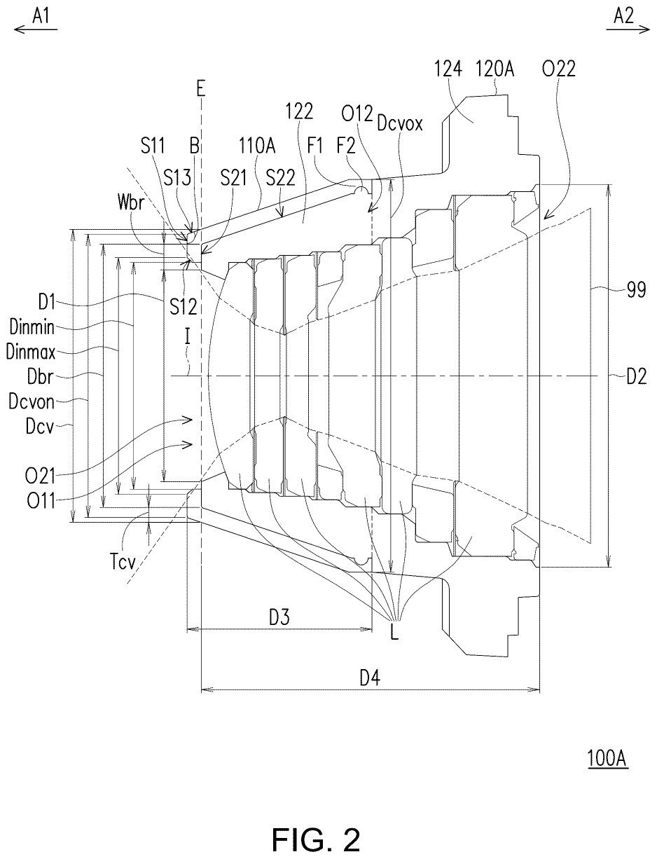

FIG. 2 is a schematic cross-sectional view of an optical imaging lens according to the second embodiment of the disclosure. Referring to FIG. 2, an optical imaging lens 100A in this embodiment is similar to the optical imaging lens 100 shown in FIG. 1. A difference between the two is that in this embodiment, an outer cover 110A and a lens barrel 120A are formed by insert injection. In this embodiment, the outer cover 110A includes at least one outer cover embedding structure F1, and the lens barrel 120A includes at least one lens barrel embedding structure F2. The outer cover 110A is combined with the at least one lens barrel embedding structure F2 of the lens barrel 120A through the at least one outer cover embedding structure F1. Therefore, compared to dispensing, in this embodiment, one step may be reduced, so the process is simple, and bonding strength of insert injection is stronger than that of glue. For example, in this embodiment, the numbers of the at least one outer cover embedding structure F1 and the at least one lens barrel embedding structure F2 are the same. The at least one lens barrel embedding structure F2 is a protruding structure, and is adjacent to the outer cover image-side opening O12. In this way, a bonding area may be further increased, and bonding force of the outer cover 110A may be strengthened. In this embodiment, the included angle B between the outer cover annular plane S11 and the outer cover conical surface S13 is 100 degrees. In addition, a relationship between various important parameters of the optical imaging lens 100A in the second embodiment is shown in FIG. 9.

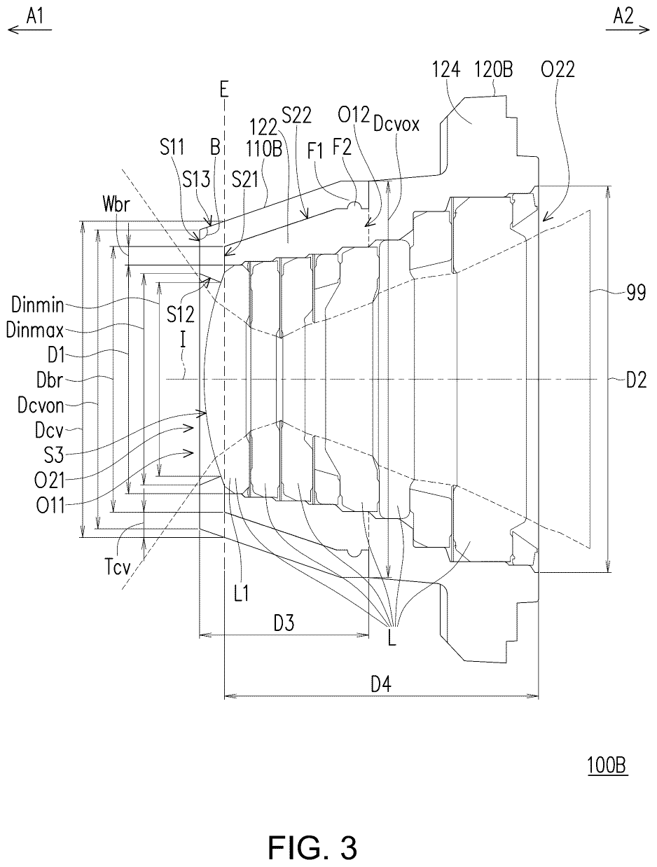

FIG. 3 is a schematic cross-sectional view of an optical imaging lens according to the third embodiment of the disclosure. Referring to FIG. 3, an optical imaging lens 100B in this embodiment is similar to the optical imaging lens 100 shown in FIG. 1. A difference between the two is that in this embodiment, an outer cover 110B and a lens barrel 120B are formed by insert injection. In this embodiment, the outer cover 110B includes the at least one outer cover embedding structure F1, and the lens barrel 120B includes the at least one lens barrel embedding structure F2. The outer cover 110B is combined with the at least one lens barrel embedding structure F2 of the lens barrel 120B through the at least one outer cover embedding structure F1. Therefore, compared to dispensing, in this embodiment, one step may be reduced, so the process is simple, and the bonding strength of insert injection is stronger than that of the glue. For example, in this embodiment, the numbers of the at least one outer cover embedding structure F1 and the at least one lens barrel embedding structure F2 are the same. The at least one lens barrel embedding structure F2 is the protruding structure, and is adjacent to the outer cover image-side opening O12. In this way, the bonding area may be further increased, and bonding force of the outer cover 110B may be strengthened. In addition, in this embodiment, one of the lens elements L closest to the object side A1 is a first lens element L1, and the outer cover 110B is in contact with an object-side surface S3 of the first lens element L1. In this way, a length of the lens barrel 120B may be shortened, thereby reducing a total length of the optical imaging lens 100B and preventing the lens barrel 120B from being in direct contact with other materials and being corroded. In this embodiment, the included angle B between the outer cover annular plane S11 and the outer cover conical surface S13 is 105 degrees. In addition, a relationship between various important parameters of the optical imaging lens 100B in the third embodiment is shown in FIG. 9.

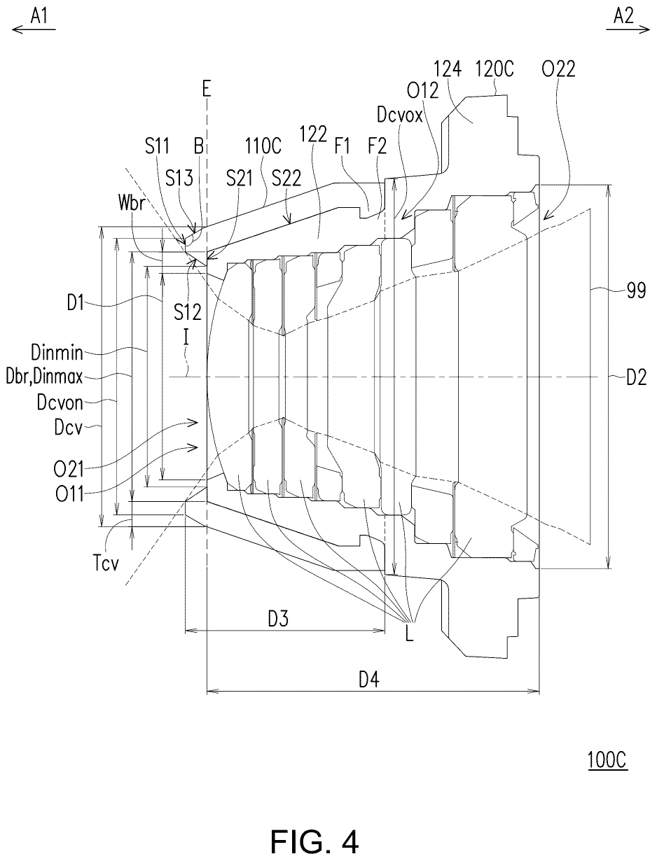

FIG. 4 is a schematic cross-sectional view of an optical imaging lens according to the fourth embodiment of the disclosure. Referring to FIG. 4, an optical imaging lens 100C in this embodiment is similar to the optical imaging lens 100 shown in FIG. 1. A difference between the two is that in this embodiment, an outer cover 110C and a lens barrel 120C are formed by insert injection. In this embodiment, the outer cover 110C includes the at least one outer cover embedding structure F1, and the lens barrel 120C includes the at least one lens barrel embedding structure F2. The outer cover 110C is combined with the at least one lens barrel embedding structure F2 of the lens barrel 120C through the at least one outer cover embedding structure F1. Therefore, compared to dispensing, in this embodiment, one step may be reduced, so the process is simple, and the bonding strength of insert injection is stronger than that of the glue. For example, in this embodiment, the numbers of the at least one outer cover embedding structure F1 and the at least one lens barrel embedding structure F2 are the same. The at least one lens barrel embedding structure F2 is a groove structure, and is adjacent to the outer cover image-side opening O12. In this way, the bonding area may be further increased, and bonding force of the outer cover 110C may be strengthened. In addition, in this embodiment, the outer cover 110C may be a soft material, and a Shore A hardness thereof ranges from 70 to 90. In this embodiment, the included angle B between the outer cover annular plane S11 and the outer cover conical surface S13 is 110 degrees. In addition, a relationship between various important parameters of the optical imaging lens 100C in the fourth embodiment is shown in FIG. 9.

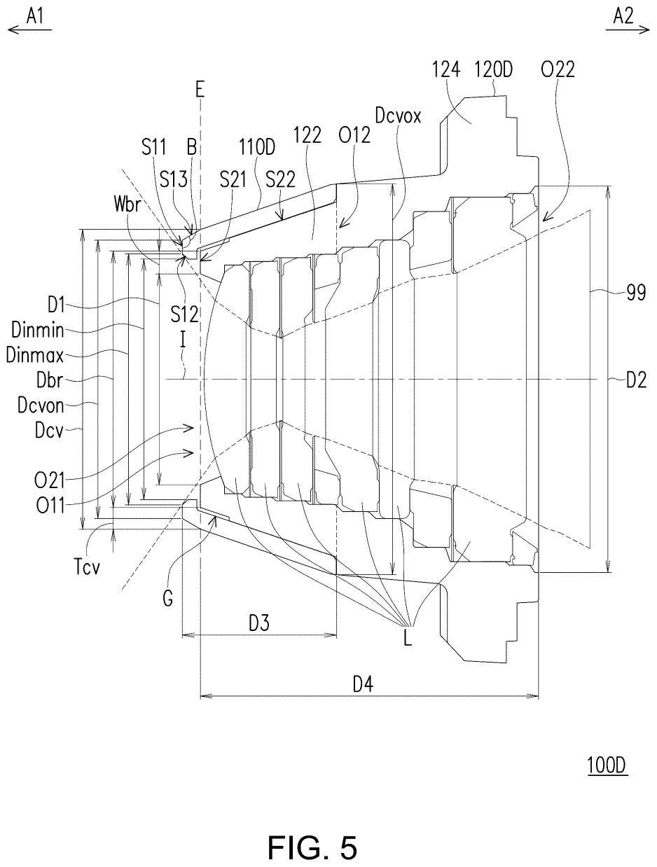

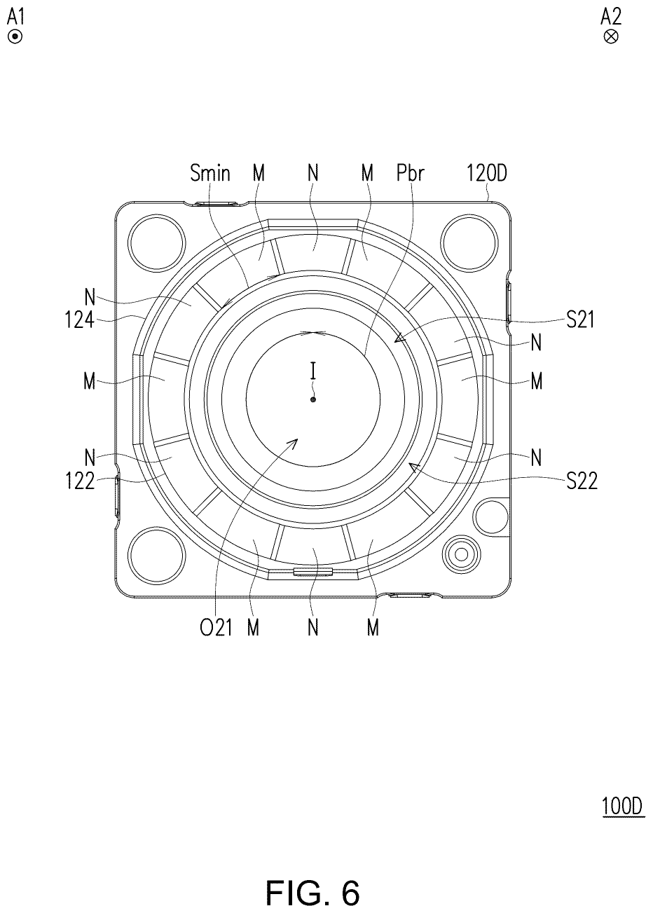

FIG. 5 is a schematic cross-sectional view of an optical imaging lens according to the fifth embodiment of the disclosure. FIG. 6 is a schematic front view of an optical imaging lens according to the fifth embodiment of the disclosure. Referring to FIG. 5 and FIG. 6, an optical imaging lens 100D in this embodiment is similar to the optical imaging lens 100 shown in FIG. 1. A difference between the two is that in this embodiment, an air gap G is disposed between the outer surface S22 of the front end portion 122 of a lens barrel 120D and an outer cover 110D. In this way, the air gap G may be used as a buffer structure to prevent the impact force from being directly transmitted to the front end portion 122 of the lens barrel 120D, thereby increasing the drop resistance. More specifically, a length of the air gap G on the optical axis I is 20% to 40% of a length of the outer cover 110D on the optical axis I. For example, in this embodiment, the length of the air gap G on the optical axis I is 30% of the length of the outer cover 110D on the optical axis I. In this way, by further designing a ratio of the length of the air gap G to the length of the outer cover 110D, an appropriate buffer capacity may be obtained, while also achieving an effect of improving an assembly yield.

On the other hand, in this embodiment, the outer surface S22 of the lens barrel 120D is provided with multiple dispensing areas M and multiple matching areas N arranged alternately. The number of dispensing areas M is the same as the number of matching areas N. More specifically, the number of dispensing areas M is at least 3 and at most 12. For example, in this embodiment, the outer surface S22 of the lens barrel 120D is provided with 6 dispensing areas M and 6 matching areas N arranged alternately. In this way, it is possible to avoid a combination of the outer cover 110D and the lens barrel 120D being unstable and failing to achieve a function of improving dimensional accuracy due to too few dispensing areas M, and to avoid the width being narrowed due to too many dispensing areas M, thereby reducing production efficiency. Each of the dispensing areas M has a receiving groove for receiving the glue, and a depth of the receiving groove is between 0.005 mm and 0.100 mm. The matching area Nis in direct contact with the outer cover 110D. In addition, a relationship between various important parameters of the optical imaging lens 100D in the fifth embodiment is shown in FIG. 9.

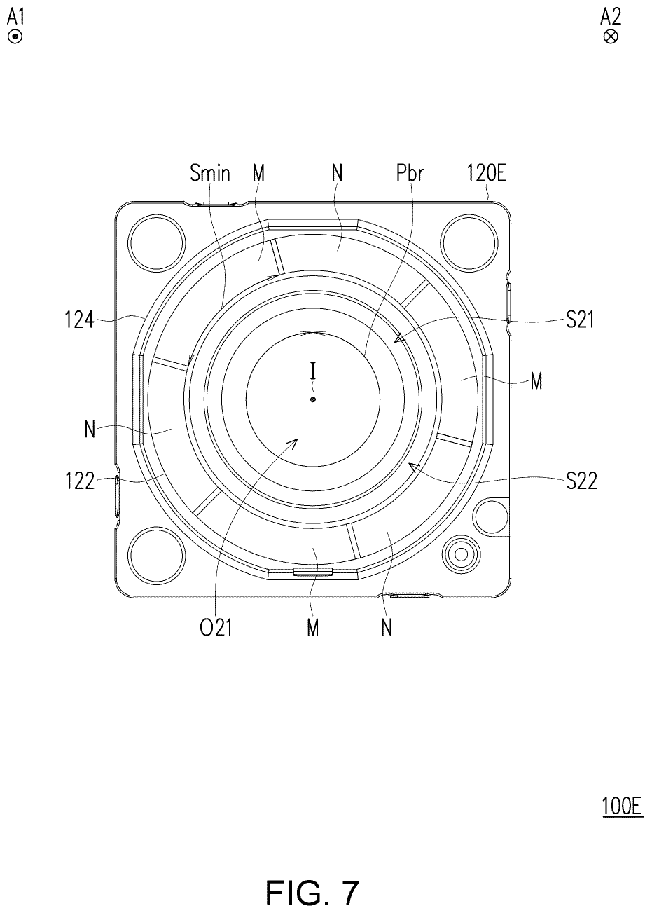

FIG. 7 is a schematic front view of an optical imaging lens according to the sixth embodiment of the disclosure. Referring to FIG. 7, for convenience of description, FIG. 7 shows the outer cover in a hidden manner. An optical imaging lens 100E in this embodiment is similar to the optical imaging lens 100D shown in FIG. 6. A difference between the two is that in this embodiment, the outer surface S22 of a lens barrel 120E is provided with 3 dispensing areas M and 3 matching areas N arranged alternately. In this way, it is possible to avoid a combination of the outer cover and the lens barrel 120E being unstable and failing to achieve the function of improving the dimensional accuracy due to too few dispensing areas M, and to avoid the width being narrowed due to too many dispensing areas M, thereby reducing the production efficiency. In addition, a relationship between various important parameters of the optical imaging lens 100E in the sixth embodiment is shown in FIG. 9.

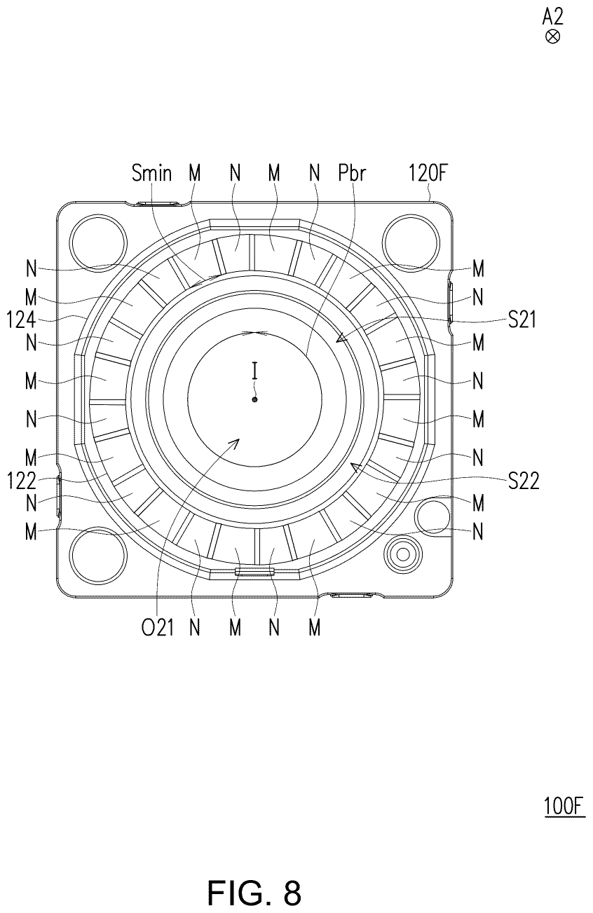

FIG. 8 is a schematic front view of an optical imaging lens according to the seventh embodiment of the disclosure. Referring to FIG. 8, for convenience of description, FIG. 8 shows the outer cover in a hidden manner. An optical imaging lens 100F in this embodiment is similar to the optical imaging lens 100D shown in FIG. 6. A difference between the two is that in this embodiment, the outer surface S22 of a lens barrel 120F is provided with 12 dispensing areas M and 12 matching areas N arranged alternately. In this way, it is possible to avoid a combination of the outer cover and the lens barrel 120F being unstable and failing to achieve the function of improving the dimensional accuracy due to too few dispensing areas M, and to avoid the width being narrowed due to too many dispensing areas M, thereby reducing the production efficiency. In addition, a relationship between various important parameters of the optical imaging lens 100F in the sixth embodiment is shown in FIG. 9.

In addition, in the above embodiments, when the optical imaging lenses 100 and 100A to 100F satisfy the following condition, 0.450≤Tcv/Wbr≤1.400, a ratio of the width Wbr of the lens barrel annular plane S21 to the thicknesses Tcv of the outer covers 110 and 110A to 110D may be controlled to maintain the volume of the miniaturized lens while ensuring intensity of the drop resistance of the optical imaging lenses 100 and 100A to 100F.

In addition, in the above embodiments, when the optical imaging lenses 100 and 100A to 100F satisfy the following condition, 1.120≤Dcv/Dbr≤1.201, a ratio of the maximum outer diameters Dbr of the lens barrels 120 and 120A to 120F to the maximum outer diameters Dcv of the outer covers 110 and 110A to 110D on the same plane may be controlled to maintain the volume of the miniaturized lens while ensuring the intensity of the drop resistance of the optical imaging lenses 100 and 100A to 100F.

In addition, in the above embodiments, when the optical imaging lenses 100 and 100A to 100F satisfy the following condition, 1.000≤Dinmax/Dinmin≤1.400, a slope of the conical surface S12 may be controlled by controlling a ratio of the maximum inner diameter Dinmax to the minimum inner diameter Dinmin of the inner ring conical surface S12 of the outer cover object-side opening O11, so as to achieve an effect of reducing the stray light.

In addition, in the above embodiments, when the optical imaging lenses 100 and 100A to 100F satisfy the following condition, 1.150≤Dcvox/Dcvon≤1.500, a slope of conical shapes of the outer covers 110 and 110A to 110D may be controlled by a ratio of the maximum outer diameter Dcvox to the minimum outer diameter Devon of the outer covers 110 and 110A to 110D, so as to achieve an effect of controlling and dispersing the impact force and reducing the stress concentration.

In addition, in the fifth to seventh embodiments, when the optical imaging lenses 100D, 100E, and 100F further satisfy the following condition, 3.100≤Pbr/Smin≤12.50, Pbr is a minimum circumference of the lens barrel object-side opening O21, and Smin is a minimum arc length of one of the dispensing areas M close to the object side A1. In this way, a dispensing area may be adjusted by controlling the arc length of the dispensing area M, and appropriate sizes of the lens barrels 120D, 120E, and 120F may be matched to improve the deformation of the lens barrels 120D, 120E, and 120F and improve a manufacturing yield.

Regarding the placement and selection of the colloid of the present embodiment, thermosetting adhesive is most commonly used in the industry for lens assembly. This is because thermosetting adhesive undergoes an irreversible chemical cross-linking reaction upon heating, transforming from a liquid to a solid. Therefore, after curing, the thermosetting adhesive may not soften or melt again, achieving advantages such as high heat resistance and chemical resistance. This high heat resistance and chemical resistance facilitate passing high-temperature and low-temperature cycling reliability testing. However, when the coefficient of thermal expansion of the lens barrel 120 is between 4 times and 10 times the coefficient of thermal expansion of the outer cover 110 (4≤CTEpc/CTEoc≤10), if the outer cover 110 is disposed on the outer surface S22 of the front end portion 122 of the lens barrel 120 via thermosetting adhesive and subjected to a heat curing process for a period of time (e.g., maintaining a temperature of 95° C. for one hour), the thermal expansion of the lens barrel 120 exceeding 4 times or more that of the outer cover 110 causes the space for the thermosetting adhesive to be squeezed and reduced during the curing process. Therefore, as the outer cover 110 and the lens barrel 120 return to room temperature, the lens barrel 120 is unable to return to the original state due to the adhesion of the lens barrel 120 to the outer cover 110 during the heating and expansion process, resulting in stress pulling and eventually causing deformation of the lens barrel 120. Therefore, the deformation of the lens barrel 120 shifts the lens position, leading to various imaging quality issues such as lens decentration. Furthermore, since the light transmittance of the outer cover 110 is less than 10% (for example, metal in the present embodiment), conventional UV adhesive may not be used for bonding. To address the above requirements for drop resistance, thickness, and material limitations, using a colloid that is solid at less than 90° C. and in a softened state when heated again to 50° C. to 75° C. may avoid the above issue of the lens barrel 120 deforming caused by heat curing. Specifically, the colloid may be reactive polyurethane (RPU), which is solid at less than 90° C. and becomes liquid when preheated to 90° C. to 120° C. The colloid is injected between the lens barrel 120 and the outer cover 110 via a syringe and cured at room temperature (1 day to 7 days), avoiding the deformation issue of the lens barrel 120 caused by heat curing. The colloid is in a softened state when heated again to 50° C. to 75° C. In particular, the preferred melting working temperature of the reactive polyurethane is 110° C. to 120° C., which is advantageous to reducing the heating time to 30 minutes, shortening the process. Moisture-curing adhesive is solid at less than 90° C. and is in a softened state when heated again to 50° C. to 75° C. In another embodiment, the colloid may be a UV delayed curing adhesive, which is a liquid at room temperature. The colloid may be injected directly onto the lens barrel 120 via a syringe and exposed to UV light. The outer cover 110 may then be assembled and cured at room temperature (1 day to 7 days). This not only avoids the issue of the outer cover 110 being opaque and unable to be used with conventional UV adhesive, but may also prevent the deformation issue of the lens barrel 120 caused by heat curing. UV delayed curing adhesive is solid at less than 90° C. and is in a softened state when heated again to 50° C. to 75° C. In particular, compared to the PSA 130, reactive polyurethane has a higher yield in automated production since the PSA 130 is produced in sheets and adhered to the conical surface S12, which is more prone to unevenness. Therefore, injecting reactive polyurethane as a liquid onto the conical surface S12 of the lens barrel 120 has a higher yield. Furthermore, regarding the choice of the colloid, while moisture-curing adhesive also avoids the heat-curing process, since the colloid is disposed between the outer cover 110 and the outer surface S22 of the front end portion 122 of the lens barrel 120, the surface area exposed to moisture in the air is extremely small. Compared to reactive polyurethane and UV delayed curing adhesive, which undergo chemical reactions such as heating or UV light exposure before bonding, moisture-curing adhesive requires a longer room-temperature cure time, increasing the lens production cycle. Furthermore, the extremely small area exposed to moisture in the air may be the reason why it is difficult to pass the reliability test of the −30° C. to 75° C. cycle. Based on the above, reactive polyurethane or UV delayed curing adhesive is bonded and cured at the outer cover 110 and the outer surface S22 of the front end portion 122 of the lens barrel 120 in an environment satisfying the conditions such as 9.900≤Dcvon/Wbr≤15.500 and 4≤CTEpc/CTEoc≤10. This not only may avoid the deformation issue caused by heat curing, but also improves the yield of automated production, shortens the time and cycle of lens production, and is more advantageous to the lens passing the reliability test of the −30° C. to 75° C. cycle, thereby improving production quality and yield. The following lists the coefficients of thermal expansion of the lens barrel 120 or the outer cover 110 of different materials.

| | Coefficient of thermal |
|---|---|
| Material | expansion (ppm/° C.) |
| PC (lens barrel) | 7 |
| Stainless steel (outer cover) | 1.7 |
| Copper (outer cover) | 1.65 |
| Glass (outer cover) | 0.72 |

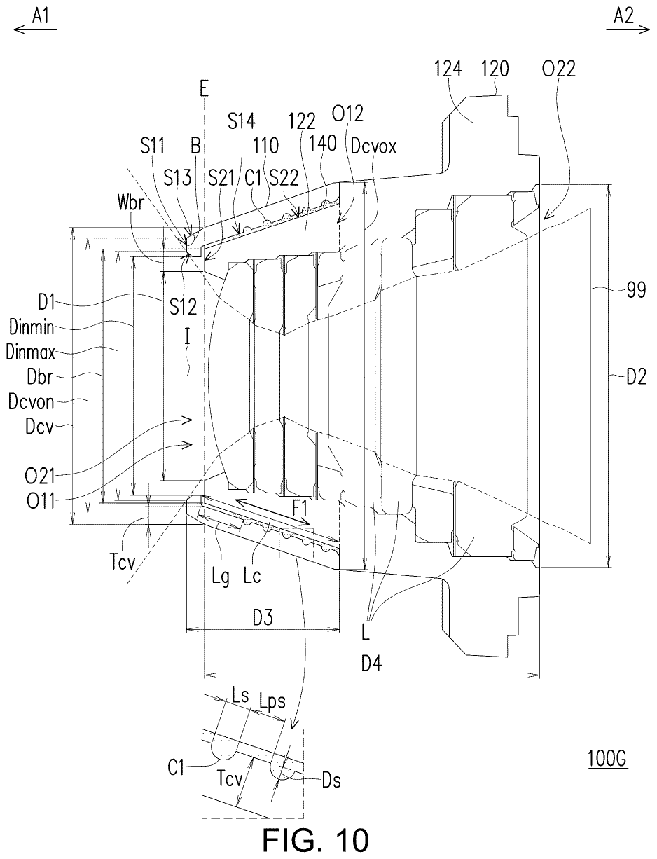

FIG. 10 is a schematic cross-sectional view of an optical imaging lens according to the eighth embodiment of the disclosure. Referring to FIG. 10, an optical imaging lens 100G in this embodiment is similar to the optical imaging lens 100 shown in FIG. 1. A difference between the two is that in this embodiment, the outer cover 110 has a cover bonding surface S14, and the lens barrel 120 and the outer cover 110 are bonded by dispensing adhesive between the outer surface S22 of the front end portion of the lens barrel 120 and the cover bonding surface S14 of the outer cover 110, for example using glue 140 (such as the thermosetting adhesive, hot melt adhesive, etc.), or using the pressure sensitive adhesive 130 in the aforementioned embodiment, and the disclosure is not limited thereto. It is worth mentioning that the cover bonding surface S14 has multiple annular grooves C1. In this way, through the annular grooves C1, a volume of the glue 140 may be increased, and a contact area between the cover bonding surface S14 and the glue 140 may be increased, so as to increase bonding force between the different materials of the lens barrel 120 and the outer cover 110, avoiding separation of the two due to dropping, thereby avoiding the deformation or damage of the lens barrel 120. In another embodiment, the annular grooves C1 may be thread-shaped structural grooves, so that multiple groove-shaped structures are spaced apart on the cross-section parallel to the optical axis I, and the disclosure is also not limited thereto.

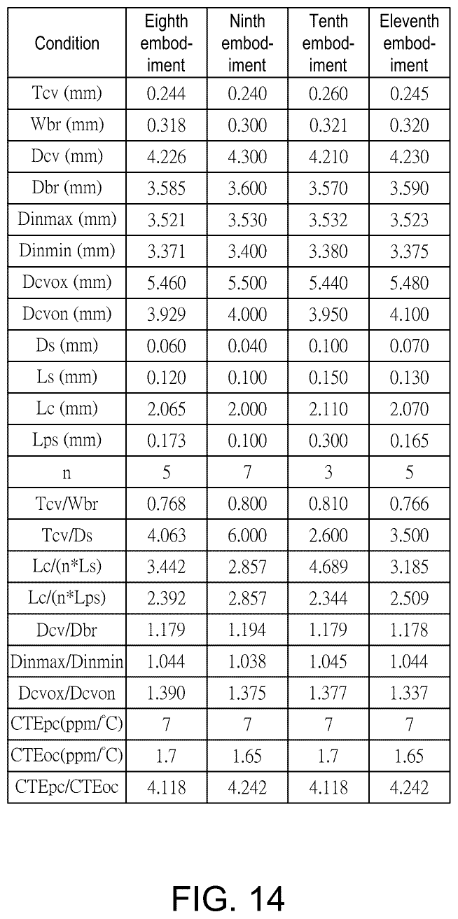

In addition, a relationship between various important parameters of the optical imaging lens 100G in the eighth embodiment is shown in FIG. 14,
where
Ds is a maximum depth of the annular groove C1;
Ls is a maximum length of each of the annular grooves C1 in a first direction F1;
Lc is a minimum length of the cover bonding surface S14 from the outer cover object-side opening O11 to the outer cover image-side opening O12;
Lps is a minimum length between any two of the adjacent annular grooves C1;
n is the number of the annular grooves C1.

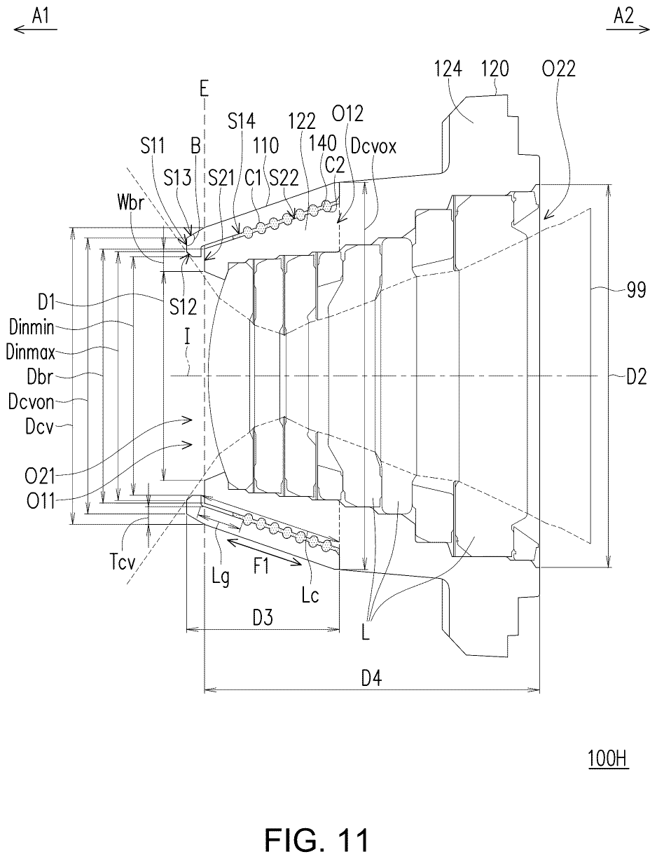

FIG. 11 is a schematic cross-sectional view of an optical imaging lens according to the ninth embodiment of the disclosure. Referring to FIG. 11, an optical imaging lens 100H in this embodiment is similar to the optical imaging lens 100G shown in FIG. 10. A difference between the two is that in this embodiment, the lens barrel 120 also has multiple annular grooves C2 similar to the annular grooves C1 of the outer cover 110, and positions of the annular grooves C1 of the outer cover 110 and positions of the annular grooves C2 of the lens barrel 120 are correspondingly disposed. In this way, through the annular grooves C1 and C2, the volume of the glue 140 may be increased, and the contact area between the cover bonding surface S14 and the glue 140 may be increased, so as to increase the bonding force between the different materials of the lens barrel 120 and the outer cover 110, avoiding the separation of the two due to dropping, thereby avoiding the deformation or damage of the lens barrel 120. In addition, a relationship between various important parameters of the optical imaging lens 100H in the ninth embodiment is shown in FIG. 14.

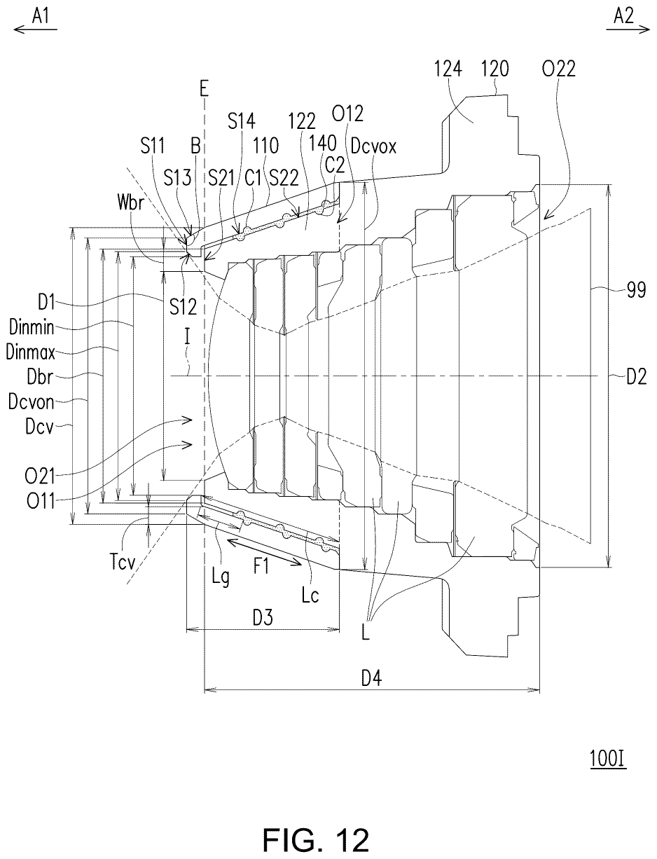

FIG. 12 is a schematic cross-sectional view of an optical imaging lens according to the tenth embodiment of the disclosure. Referring to FIG. 12, an optical imaging lens 1001 in this embodiment is similar to the optical imaging lens 100G shown in FIG. 10. A difference between the two is that in this embodiment, the lens barrel 120 also has the annular grooves C2 similar to the annular grooves C1 of the outer cover 110, and the positions of the annular grooves C1 of the outer cover 110 and the positions of the annular grooves C2 of the lens barrel 120 are disposed in a staggered manner. In this way, through the annular grooves C1 and C2, the volume of the glue 140 may be increased, and the contact area between the cover bonding surface S14 and the glue 140 may be increased, so as to increase the bonding force between the different materials of the lens barrel 120 and the outer cover 110, avoiding the separation of the two due to dropping, thereby avoiding the deformation or damage of the lens barrel 120. In addition, a relationship between various important parameters of the optical imaging lens 1001 in the tenth embodiment is shown in FIG. 14.

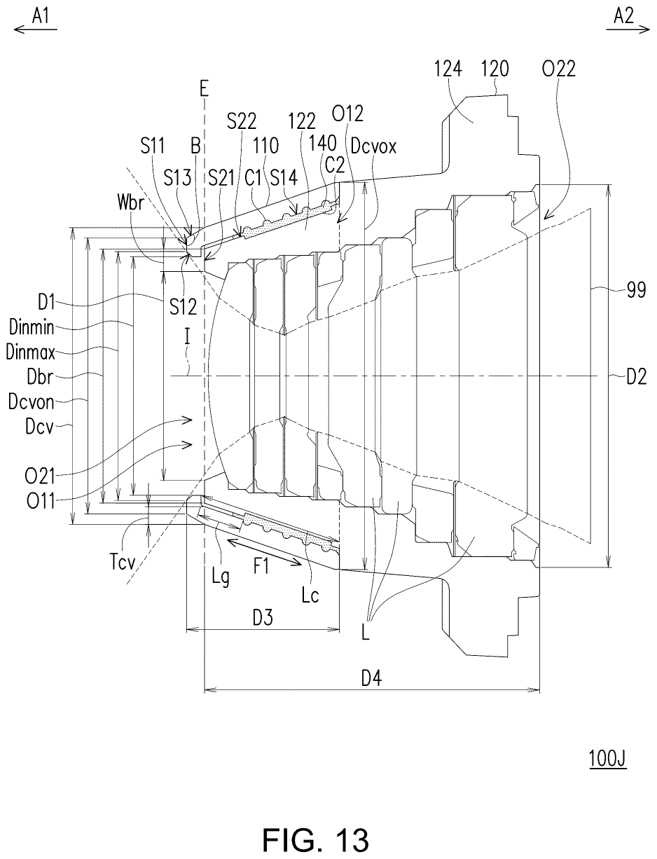

FIG. 13 is a schematic cross-sectional view of an optical imaging lens according to the eleventh embodiment of the disclosure. Referring to FIG. 13, an optical imaging lens 100J in this embodiment is similar to the optical imaging lens 100G shown in FIG. 10. A difference between the two is that in this embodiment, the lens barrel 120 has one annular groove C2. If a direction from the outer cover object-side opening O11 to the outer cover image-side opening O12 along the cover bonding surface S14 is defined as the first direction F1, a bottom of this annular groove C2 extends flatly along the first direction F1. In this way, through the annular grooves C1 and C2, the volume of the glue 140 may be increased, and the contact area between the cover bonding surface S14 and the glue 140 may be increased, so as to increase the bonding force between the different materials of the lens barrel 120 and the outer cover 110, avoiding the separation of the two due to dropping, thereby avoiding the deformation or damage of the lens barrel 120. In addition, a relationship between various important parameters of the optical imaging lens 100J in the eleventh embodiment is shown in FIG. 14.

In addition, in the above eighth to eleventh embodiments, when the optical imaging lens 100G to 100J satisfy the following condition, 2.600≤Tcv/Ds≤6.000, a better ratio of the thickness Tcv of the outer cover 110 to the depth Ds of the annular groove C1 may be obtained, avoiding the annular groove C1 being too shallow to effectively increase the volume of the glue 140, thereby failing to achieve a purpose of increasing the bonding force. Alternatively, when the annular groove C1 is too deep, it easily causes the outer cover 110 to be locally too thin, thereby losing a function of protecting the lens barrel 120.

In addition, since a volume of the optical imaging lens 100G is very small, a size of an end close to the outer cover object-side opening O11 is even smaller, so structural strength thereof is lower. Therefore, in the above eighth to eleventh embodiments, the minimum distance Lg from the outer cover object-side opening O11 of the outer cover 110 to the annular groove C1 may be designed to be between 0.550 to 0.700 mm. By reserving the distance Lg from the outer cover object-side opening O11 to the annular groove C1, the overall structural strength of the end of the outer cover object-side opening O11 is maintained, avoiding deformation of the outer cover 110 due to dropping, and losing the function of protecting the lens barrel 120.

In addition, in the above eighth to eleventh embodiments, when the optical imaging lens 100G to 100J satisfy the following condition, 2.800≤Lc/(n*Ls)≤4.700, the annular groove C1 may be designed in a better ratio, avoiding an overall area of the annular groove C1 occupying too high a ratio of the cover bonding surface S14, which causes overall strength of the outer cover 110 to decrease, and avoiding the ratio of the annular groove C1 occupying the cover bonding surface S14 being too low, which is unable to effectively increase the contact area between the cover bonding surface S14 and the glue 140, thereby failing to achieve the purpose of increasing the bonding force.

On the other hand, in the above eighth to eleventh embodiments, these annular grooves C1 are disposed periodically. Through the periodic arrangement, the annular grooves C1 may be evenly distributed on the cover bonding surface S14, evenly increasing the contact area between the cover bonding surface S and the glue 140, thereby better improving the bonding force between the different materials of the outer cover 110 and the lens barrel 120.

In addition, in the above eighth to eleventh embodiments, when the optical imaging lens 100G satisfies the following condition, 2.300≤Lc/(n*Lps)≤29.000, the annular groove C1 may be designed in a better ratio, avoiding the ratio of the annular groove C1 occupying the cover bonding surface S14 per unit area being too high, which causes the strength of the outer cover 110 in partial areas to decrease, and avoiding the ratio of the annular groove C1 occupying the cover bonding surface S14 in partial areas being too low, which is unable to effectively increase the contact area between the cover bonding surface S14 and the glue 140, thereby failing to achieve the purpose of increasing the bonding force.

Based on the above, in the optical imaging lens of the disclosure, the optical imaging lens includes the outer cover, the lens barrel, and the lens elements disposed in the lens barrel along the optical axis from the object side to the image side. The front end portion of the lens barrel includes the lens barrel object-side opening, and the back end portion of the lens barrel includes the lens barrel image-side opening. The inner diameter of the lens barrel object-side opening is less than the inner diameter of the lens barrel image-side opening. Therefore, it is not only advantageous to arrange the outer cover, the lens barrel, and the lens elements in sequence for easy assembly, but also advantageous to reduce the volume of the optical imaging lens while maintaining the wall thickness of the lens barrel. In addition, the outer cover includes the outer cover object-side opening and the outer cover image-side opening, and the maximum outer diameter of the outer cover object-side opening is less than the maximum outer diameter of the outer cover image-side opening. Therefore, the configuration of the outer cover may help to improve the strength of the front end portion of the lens barrel. In addition, the length of the outer cover on the optical axis is greater than 40% of the length of the lens barrel on the optical axis. Therefore, the protection area of the lens barrel may be increased, and the bonding force between the outer cover and the lens barrel may also be increased, thereby improving the drop resistance. In addition, the cone shape of the outer cover is not only easy to process, but also may disperse the impact force when it is disposed on the outer surface of the lens barrel. The design thereof without the chamfered structure may also reduce the stress concentration, which may effectively avoid the external impacts or drops, thereby reducing the possibility of local deformation and protecting the safety of the internal components. In addition, the optical imaging lens satisfies the following condition, 0.450≤Tcv/Wbr≤1.400, where Tcv is the thickness of the outer cover on the reference plane, and Wbr is the width of the lens barrel annular plane on the reference plane. Therefore, by controlling the ratio of the width of the lens barrel annular plane to the thickness of the outer cover, the volume of the miniaturized lens may be maintained while ensuring the intensity of the drop resistance of the optical imaging lens.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. An optical imaging lens, comprising an outer cover, a lens barrel, and a plurality of lens elements disposed in the lens barrel from an object side to an image side along an optical axis, wherein
the lens barrel comprises a front end portion close to the object side and a back end portion close to the image side;
the front end portion comprises a lens barrel object-side opening, the back end portion comprises a lens barrel image-side opening, and an inner diameter of the lens barrel object-side opening is less than an inner diameter of the lens barrel image-side opening;
the front end portion of the lens barrel has a lens barrel annular plane perpendicular to the optical axis and located on a reference plane;
the outer cover being cone-shaped and disposed on an outer surface of the front end portion of the lens barrel;
the outer cover comprises an outer cover object-side opening and an outer cover image-side opening, and a maximum outer diameter of the outer cover object-side opening is less than a maximum outer diameter of the outer cover image-side opening;
the outer cover has an outer cover annular plane close to the object side and perpendicular to the optical axis, and an inner ring conical surface and an outer cover conical surface adjacent to the outer cover annular plane;
a length of the outer cover on the optical axis is greater than 40% of a length of the lens barrel on the optical axis; and
the optical imaging lens satisfies a following condition, 0.450≤Tcv/Wbr≤1.400, wherein Tcv is a thickness of the outer cover on the reference plane, and Wbr is a width of the lens barrel annular plane on the reference plane.

2. The optical imaging lens according to claim 1, further comprising a colloid disposed between the outer cover and the lens barrel.

3. The optical imaging lens according to claim 1, wherein a material of the outer cover is metal.

4. The optical imaging lens according to claim 1, wherein the optical imaging lens satisfies a following condition, 1.120≤Dcv/Dbr≤1.201, wherein Dcv is a maximum outer diameter of the outer cover on the reference plane, and Dbr is a maximum outer diameter of the lens barrel on the reference plane.

5. The optical imaging lens according to claim 1, wherein the optical imaging lens satisfies a following condition, 1.000≤Dinmax/Dinmin≤1.400, wherein Dinmax is a maximum inner diameter of an inner ring conical surface, and Dinmin is a minimum inner diameter of the inner ring conical surface.

6. The optical imaging lens according to claim 1, wherein the optical imaging lens satisfies a following condition, 1.150≤Dcvox/Dcvon≤1.500, wherein Dcvox is a maximum outer diameter of the outer cover, and Devon is a minimum outer diameter of the outer cover.

7. The optical imaging lens according to claim 1, wherein the optical imaging lens satisfies a following condition, 4≤CTEpc/CTEoc≤10, wherein CTEpc is a thermal expansion coefficient of the lens barrel, and CTEoc is a thermal expansion coefficient of the outer cover.

8. The optical imaging lens according to claim 2, wherein the colloid is solid at less than 90° C., and is in a softened state when heated again to 50° C. to 75° C.

9. An optical imaging lens, comprising an outer cover, a lens barrel, and a plurality of lens elements disposed in the lens barrel from an object side to an image side along an optical axis, wherein
a material of the outer cover is different from a material of the lens barrel;
the lens barrel comprises a front end portion close to the object side and a back end portion close to the image side;
the front end portion comprises a lens barrel object-side opening, the back end portion comprises a lens barrel image-side opening, and an inner diameter of the lens barrel object-side opening is less than an inner diameter of the lens barrel image-side opening;
the front end portion of the lens barrel has a lens barrel annular plane perpendicular to the optical axis and located on a reference plane;
the outer cover being cone-shaped and disposed on an outer surface of the front end portion of the lens barrel;
the outer cover comprises an outer cover object-side opening and an outer cover image-side opening, and a maximum outer diameter of the outer cover object-side opening is less than a maximum outer diameter of the outer cover image-side opening;
the outer cover has a cover bonding surface, the lens barrel and the outer cover are bonded by dispensing adhesive between the outer surface and the cover bonding surface, and the cover bonding surface has a plurality of annular grooves;
the optical imaging lens satisfies a following condition, 2.600≤Tcv/Ds≤6.000, wherein Tcv is a thickness of the outer cover on the reference plane, and Ds is a maximum depth of the annular grooves.

10. The optical imaging lens according to claim 9, further comprising a colloid disposed between the outer cover and the lens barrel.

11. The optical imaging lens according to claim 9, wherein a material of the outer cover is metal.

12. The optical imaging lens according to claim 9, wherein a minimum distance from the outer cover object-side opening of the outer cover to the annular grooves is between 0.550 to 0.700 mm.

13. The optical imaging lens according to claim 9, wherein the optical imaging lens satisfies a following condition, 2.800≤Lc/(n*Ls)≤4.700, from the outer cover object-side opening to the outer cover image-side opening along the cover bonding surface is a first direction, wherein Lc is a minimum length of the cover bonding surface from the outer cover object-side opening to the outer cover image-side opening, Ls is a maximum length of each of the annular grooves in the first direction, and n is a number of the annular grooves.

14. The optical imaging lens according to claim 9, wherein the annular grooves are disposed periodically.

15. The optical imaging lens according to claim 9, wherein the optical imaging lens satisfies a following condition, 2.300≤Lc/(n*Lps)≤2.900, wherein Lc is a minimum length of the cover bonding surface from the outer cover object-side opening to the outer cover image-side opening, Lps is a minimum length between any two adjacent ones of the annular grooves, and n is a number of the annular grooves.

16. The optical imaging lens according to claim 9, wherein the optical imaging lens satisfies a following condition, 1.120≤Dcv/Dbr≤1.201, wherein Dcv is a maximum outer diameter of the outer cover on the reference plane, and Dbr is a maximum outer diameter of the lens barrel on the reference plane.

17. The optical imaging lens according to claim 9, wherein the optical imaging lens satisfies a following condition, 1.000≤Dinmax/Dinmin≤1.400, wherein Dinmax is a maximum inner diameter of an inner ring conical surface, and Dinmin is a minimum inner diameter of the inner ring conical surface.

18. The optical imaging lens according to claim 9, wherein the optical imaging lens satisfies a following condition, 1.150≤Dcvox/Dcvon≤1.500, wherein Dcvox is a maximum outer diameter of the outer cover, and Devon is a minimum outer diameter of the outer cover.

19. The optical imaging lens according to claim 9, wherein the optical imaging lens satisfies a following condition, 4≤CTEpc/CTEoc≤10, wherein CTEpc is a thermal expansion coefficient of the lens barrel, and CTEoc is a thermal expansion coefficient of the outer cover.

20. The optical imaging lens according to claim 10, wherein the colloid is solid at less than 90° C., and is in a softened state when heated again to 50° C. to 75° C.
